(19) United States
(12) Patent Application Publication
(10) Pub. No.: US 2019/0063614 A1
(43) Pub. Date: Feb. 28, 2019

(54) SCREW VALVE HAVING ENHANCED AIRTIGHT EFFECT

(71) Applicant: TangTring Seating Technology Inc., Huizhou (CN)

(72) Inventor: ZU-JUN YIN, Huizhou (CN)

(21) Appl. No.: 15/684,624

(22) Filed: Aug. 23, 2017

(51) Int. Cl. F16K 1/04; F16K 31/04

(52) U.S. Cl. CPC F16K 1/04; F16K 31/048

(57) ABSTRACT

A screw valve having an enhanced airtight effect comprises a valve body, a shield assembly, and a drive assembly. The valve body has a valve port, the shield assembly is mounted in the valve body to have an opened state and a closed state for the valve port, and the drive assembly is mounted in the valve body to provide power, and at least comprises an elastic assembly form the closed state, and a transmission screw to form the opened state at a position of the valve port. The elastic assembly provides an elastic force for the shield assembly in the closed state, ensuring that the shield assembly keeps the closed state at the valve port, and the airtight effect of the screw valve is enhanced.

### FIELD OF THE INVENTION

The present invention relates to a screw valve, and in particular, to a screw valve having an enhanced airtight effect.

### BACKGROUND OF THE INVENTION

A screw valve is a valve body that can accurately adjust a flow, for which a stepper motor is mainly used to drive a screw to open or close the valve, to control a gas flow.

For a general gas valve, a gas charging valve is mainly used to connect a gas pump and a to-be-inflated object, to import a gas by using the gas pump and achieve a gas charging effect for the to-be-inflated object via the gas charging valve, and prevent leakage of the gas in the to-be-inflated object by using the gas charging valve. When the gas needs to be discharged from the to-be-inflated object, mainly, a gas discharging valve is additionally connected to the to-be-inflated object or the gas charging valve, to achieve a gas discharging effect for the gas in the to-be-inflated object via the gas discharging valve.

The China invention patent No. CN201896987U discloses a stepper motor structure of a gas valve and a gas valve. The gas valve includes a valve body and a stepper motor structure of a gas valve. The valve body has a gas channel and a gate inside. The stepper motor structure of the gas valve is disposed on the valve body, including: a housing, where the housing is internally provided with multiple brake coils and an accommodating groove; a lead screw having multiple threads, where an end of the lead screw penetrates the accommodating groove in a scalable manner, the lead screw has at least two threaded sections, and the threaded sections surround the lead screw having the multiple threads; an elastic assembly sleeved on the lead screw; and a check valve plug disposed at a position corresponding to the gate, where the check valve plug is fixedly disposed on an end of the lead screw, and moves between an opened position and a closed position. When the check valve plug is at the opened position, the check valve plug automatically returns to the closed position from the opened position, to lid the gate.

In the foregoing patent, the stepper motor is used to drive the lead screw to control the gate to be opened or closed, and the elastic assembly is used so that the check valve plug can automatically return to the closed position. Mainly, when the check valve plug is at the opened position, the elastic assembly is compressed, so that the elastic assembly provides an elastic return force to drive the check valve plug to return to the closed position. However, when the gas valve is used a long time, the elastic assembly is easily fatigue. Consequently, the check valve plug cannot effectively fit the gate, leading to gas leakage.

In view of this, how to provide a screw valve having an enhanced airtight effect is a problem to be resolved by the present invention.

### SUMMARY OF THE INVENTION

A main objective of the present invention is to provide a screw valve having an enhanced airtight effect.

To achieve the foregoing objective, the present invention provides a screw valve, including: a valve body, a shield assembly, and a drive assembly. The valve body has a gas charging channel, a gas inlet, and a gas chamber communicating the gas charging channel and the gas inlet, and a valve port is formed between the gas chamber and the gas charging channel and is connected to them. The shield assembly is mounted in the gas chamber to have an opened state and a closed state for the valve port. The drive assembly is mounted in the valve body, and includes a transmission screw, a transmission component, an elastic assembly, and a drive unit. The transmission screw extends into the gas chamber and is connected to the shield assembly, a gap is formed between the shield assembly and the transmission screw, the transmission component is connected between the transmission screw and the drive unit, the elastic assembly is disposed between the shield assembly and the transmission component, and provides an elastic force for the shield assembly, and the drive unit provides power. When the drive unit provides the power, the transmission screw is driven to drive the shield assembly away from the valve port to form the opened state, and when the drive unit does not provide the power, the shield assembly is driven by the transmission screw to approach the valve port, and the elastic force of the elastic assembly pushes the shield assembly to shield the valve port, to form the closed state, to enhance an airtight effect between the shield assembly and the valve port by using the elastic force of the elastic assembly.

In an embodiment, the shield assembly further includes a shield component closing the valve port, a bracket connected to the shield component, and a connecting piece configured to connect the shield component and the bracket to the transmission screw, so that the gap is formed between the shield assembly and the bracket and the transmission screw by using the connecting piece.

In an embodiment, the shield component is further provided with a first embedding portion, and the bracket is provided with a second embedding portion that is embedded with the first embedding portion.

In an embodiment, an accommodating space is formed between the shield component and the bracket, a through hole is formed in a direction from the accommodating space to the transmission screw, and the connecting piece is disposed in the accommodating space, and is connected with the transmission screw by using the through hole from the accommodating space.

In an embodiment, a boss is further formed around the valve port, and the boss extends into the gas chamber in a direction from the gas charging channel to the gas chamber, and fits the shield assembly to form the closed state.

In an embodiment, the drive unit further includes a stepper motor and an underdriving gear set, to provide the power by using the stepper motor and then transfer the power to the transmission component by using the underdriving gear set

In an embodiment, the transmission component further includes a fixing component and a shaft sleeve, the fixing component is fixed in the gas chamber so that the elastic assembly is disposed between the shield assembly and the transmission component, the shaft sleeve is disposed between the fixing component and the underdriving gear set, and is connected with the underdriving gear set, and the transmission screw is connected with the shaft sleeve by using the fixing component, to drive, by using the shaft sleeve, the transmission screw to move on the fixing component along an extension direction of a shaft lever.

In an embodiment, the transmission component is further internally provided with a screw transmission mechanism sleeved on the transmission screw.

Compared with the prior art, seen from the foregoing technical content, the present invention is characterized as follows:

As regards the screw valve, the shield assembly may be driven by using the transmission screw to form the closed state for the valve port, the gap between the shield assembly and the transmission screw is adjusted by using the connecting piece, and the elastic assembly provides the elastic force for the shield assembly in the closed state, to ensure that the shield assembly keeps the closed state at the valve port, and the airtight effect of the screw valve is enhanced.

### BRIEF DESCRIPTION OF THE DRAWINGS

FIG. 1 is a schematic three-dimensional diagram of the present invention applied to a gas valve assembly;

FIG. 2 is a schematic diagram of part decomposition of the gas valve assembly of the present invention;

FIG. 3 is a schematic decomposition diagram of the present invention applied to a valve base;

FIG. 4 is a schematic cross-sectional diagram of a first action of the present invention;

FIG. 5 is a schematic cross-sectional diagram of a second action of the present invention; and

FIG. 6 is a schematic cross-sectional diagram of local magnification of a shield assembly of the present invention.

### DETAILED DESCRIPTION OF THE PREFERRED EMBODIMENTS

Technical content of the present invention is described below in detail with reference to the accompanying drawings:

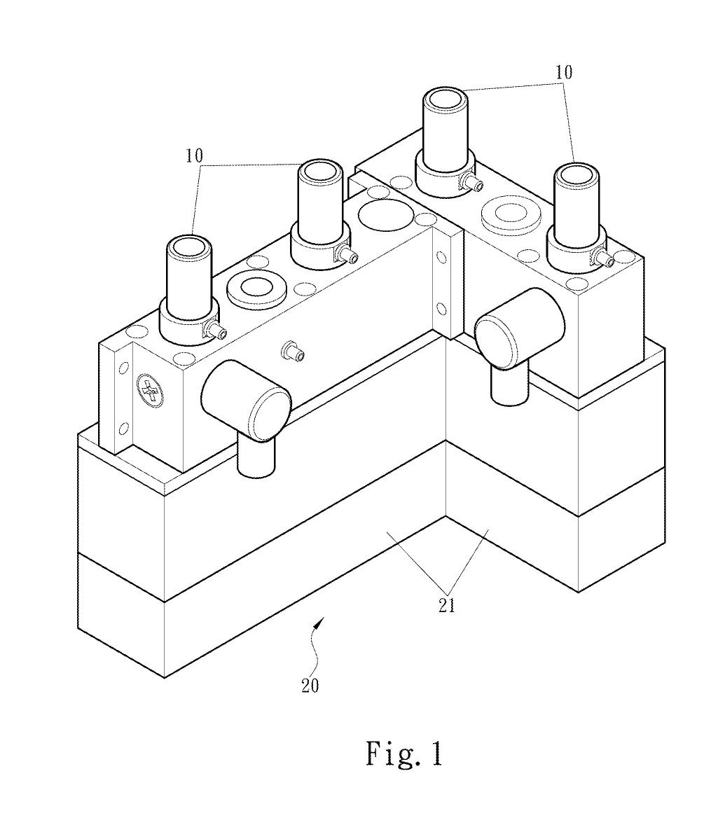

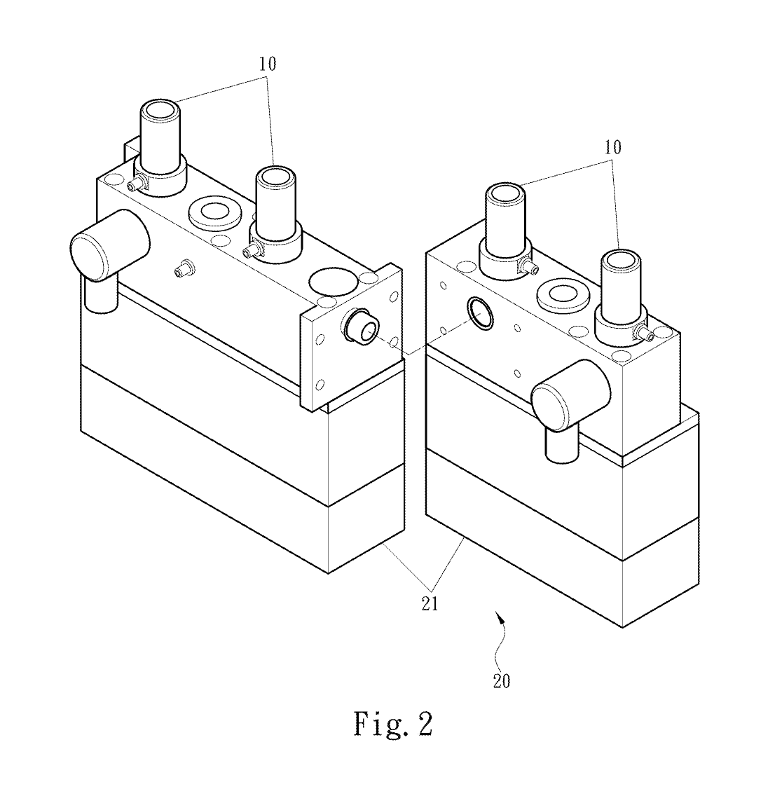

As shown in FIG. 1 and FIG. 2, the present invention provides a screw valve 10 having an enhanced airtight effect. The screw valve 10 is applied to a gas valve assembly 20. In this embodiment, the gas valve assembly 20 includes two valve bases 21, each of the valve bases 21 is internally provided with two screw valves 10, and each of the valve bases 21 is connected to a gas pump (which belongs to a conventional technology, and is not described herein).

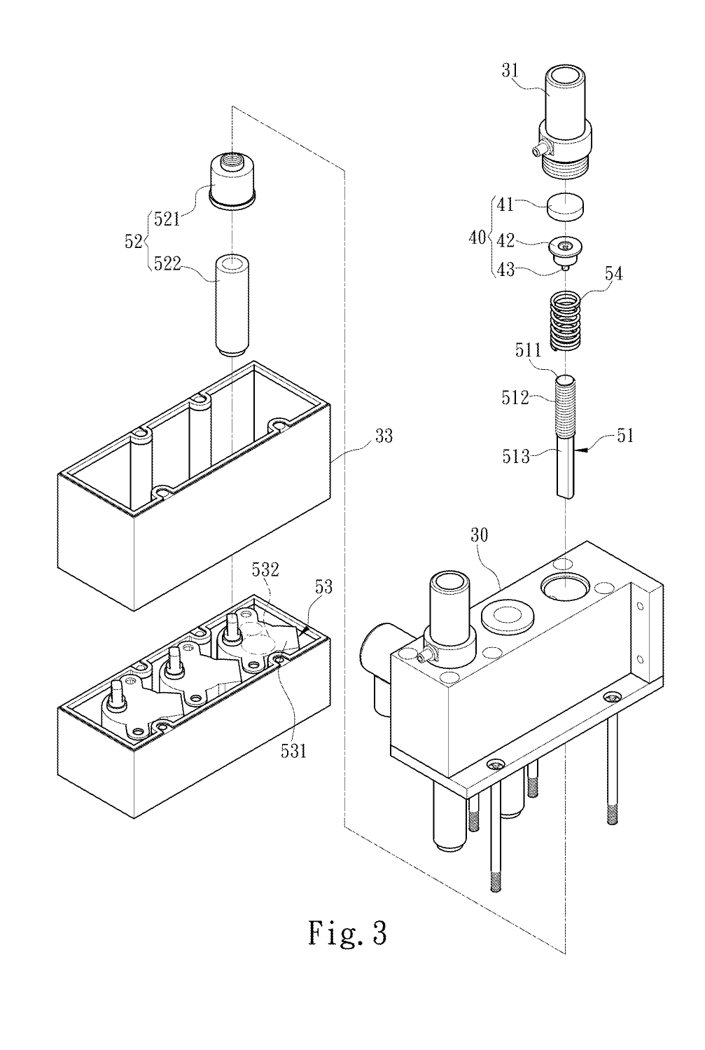

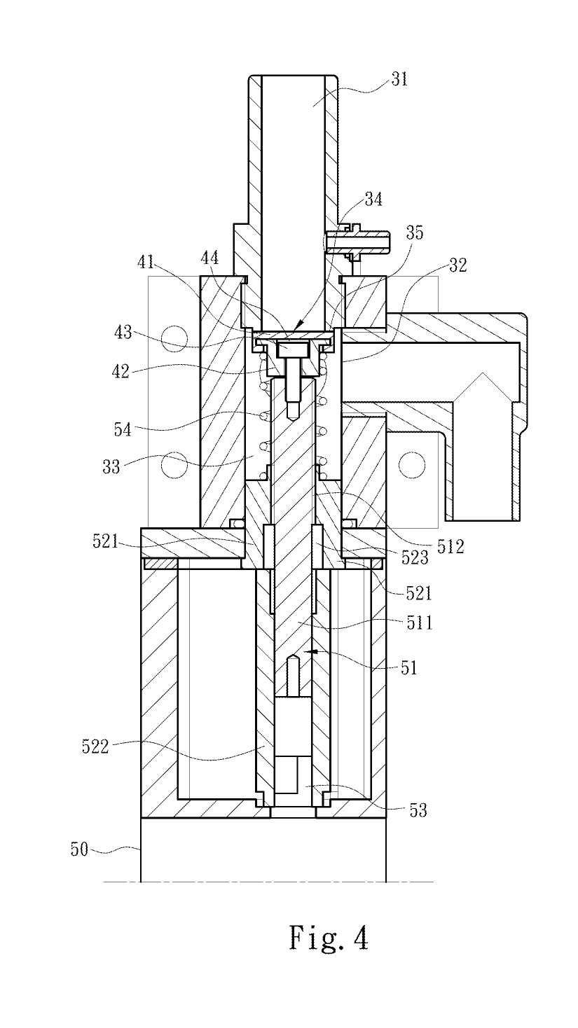

As shown in FIG. 3 and FIG. 4, each of the screw valves 10 includes a valve body 30 formed by the valve base 21, a shield assembly 40, and a drive assembly 50. The valve body 30 is internally provided with a gas charging channel 31 connected to a to-be-inflated object (which belongs to a conventional technology, and is not described herein), a gas inlet 32 connected to the gas pump, and a gas chamber 33 configured to connect the gas charging channel 31 and the gas inlet 32, and a valve port 34 is formed between the gas charging channel 31 and the gas chamber 33 and is connected to them. A boss 35 is formed around the valve port 34, and the boss 35 extends into the gas chamber 33 in a direction from the gas charging channel 31 to the gas chamber 33.

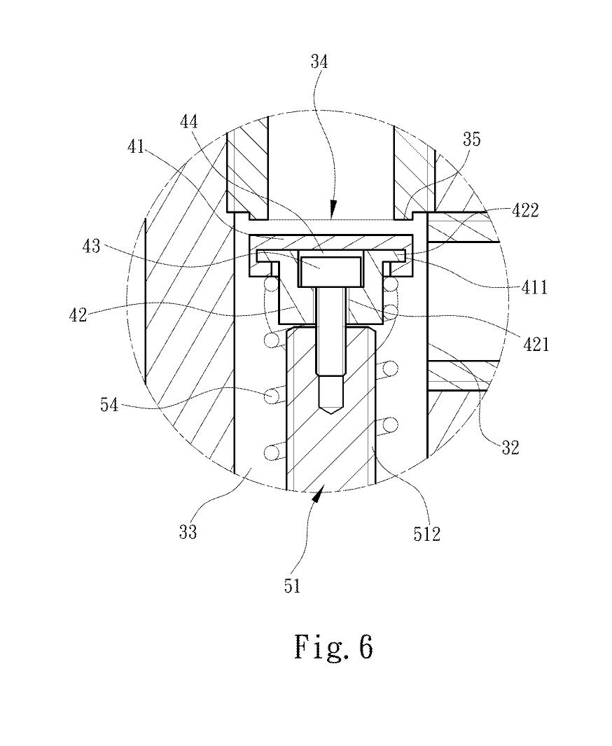

The shield assembly 40 is disposed in the gas chamber 33, and has an opened state and a closed state at a position of the valve port 34, referring to FIG. 6. The shield assembly 40 includes a shield component 41, a bracket 42, and a connecting piece 43. The shield component 41 is disposed adjacent to the valve port 34, to shield the valve port 34. The bracket 42 is connected to an end of the shield component 41 that is away from the valve port 34. An accommodating space 44 is formed between the shield component 41 and the bracket 42. The bracket 42 is provided with a through hole 421 adjacent to the accommodating space 44. The connecting piece 43 is disposed in the accommodating space 44 and extends out of the bracket 42 from the through hole 421. In this embodiment, the shield component 41 and the bracket 42 are disposed in an embedded manner. The shield component 41 is provided with a first embedding portion 411, and the bracket 42 is provided with a second embedding portion 422, so that the shield component 41 and the bracket 42 by using the first embedding portion 411 and the second embedding portion 422 are disposed in an embedded manner, and the connecting piece 43 is positioned in the accommodating space 44.

The drive assembly 50 is mounted in the valve body 30, to provide the power, to drive the shield assembly 40 to form the opened state and the closed state for the valve port 34. The drive assembly 50 includes a transmission screw 51, a transmission component 52, a drive unit 53, and an elastic assembly 54. The transmission screw 51 is disposed in the gas chamber 33 opposite to an end of the shield assembly 40 that is away from the valve port 34, and is configured to connect to the shield assembly 40. Moreover, a gap is formed between the transmission screw 51 and the shield assembly 40. In this embodiment, a top end of the transmission screw 51 is provided with a connecting portion 511 in the shape of a screw hole, and the connecting piece 43 is in the shape of a screw, so that the connecting piece 43 may be screwed to the top end of the transmission screw 51. Through collocation between the screw and the screw hole, the gap may be formed between a bottom end of the bracket 42 and the top end of the transmission screw 51, the size of the gap may be adjusted by using the screw and the screw hole, and the shield assembly 40 may move along an extension direction of the connecting piece 43 by using the gap. An upper portion of the transmission screw 51 is a screw portion 512, and a lower portion is a positioning portion 513. The transmission component 52 is disposed in the gas chamber 33 on an end away from the valve port 34, so that the gas chamber 33 forms an airtight space. In this embodiment, the transmission component 52 includes a fixing component 521, a shaft sleeve 522, and a screw transmission mechanism 523. The fixing component 521 is fixed in the gas chamber 33 on the end away from the valve port 34, so that the airtight space is formed between the valve port 34 and the fixing component 521. The shaft sleeve 522 is disposed on an end of the fixing component 521 that is away from the gas chamber 33, so that the transmission screw 51 is connected to the shaft sleeve 522 by using the fixing component 521. The positioning portion 513 of the transmission screw 51 penetrates the fixing component 521 to connect to the shaft sleeve 522. The screw portion 512 is screwed to the fixing component 521. The screw transmission mechanism 523 is positioned between the fixing component 521 and the shaft sleeve 522, and is sleeved on the positioning portion 513 of the transmission screw 51. The drive unit 53 is configured to provide the power. In this embodiment, the drive unit 53 includes a stepper motor 531 and an underdriving gear set 532. The stepper motor 531 is configured to provide the power, and is connected to the shaft sleeve 522 by using the underdriving gear set 532, to form mutual linkage among the transmission screw 51, the shaft sleeve 522, and the underdriving gear set 532. The elastic assembly 54 is disposed in the gas chamber 33, abuts between the bracket 42 and the fixing component 521, and is sleeved on the screw portion 512 of the transmission screw 51, so that an end of the elastic assembly 54 abuts against the fixing component 521, to provide an elastic force for the shield assembly 40.

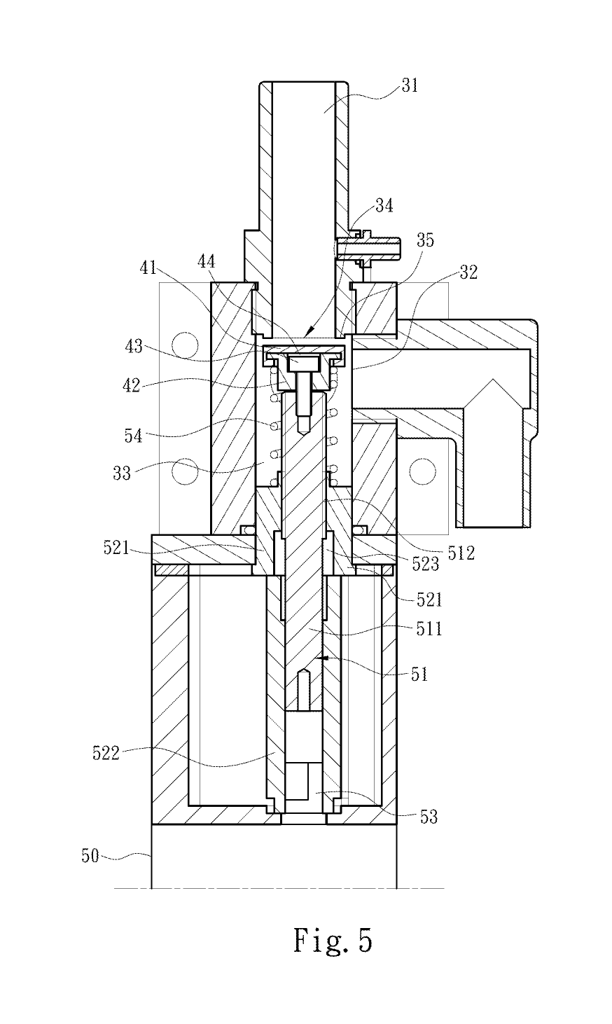

As shown in FIG. 4, FIG. 5 and FIG. 6, when the drive assembly 50 does not provide the power, the shield assembly 40 forms the closed state of the valve port 34 at the position of the valve port 34. In the closed state, the shield assembly 40 receives the elastic force of the elastic assembly 54, so that the shield assembly 40 is pushed to the valve port 34, and can keep the valve port 34 in the closed state. Therefore, the valve port 34 is kept in the closed state by using the shield assembly 40. In addition, because the boss 35 is formed around the valve port 34, when the shield component 41 abuts against the valve port 34, the boss 35 and the shield component 41 form a tighter joint, enhancing the airtight effect. On the contrary, when the drive assembly 50 drives, by using external electricity, the stepper motor 531 to provide the power, the stepper motor 531 drives the underdriving gear set 532 to move relative to the transmission screw 51 and drive the transmission screw 51 to rotate, so that the transmission screw 51 moves on the fixing component 521 along an extension direction of the transmission screw 51 in a direction from the fixing component 521 to the shaft sleeve 522. In this case, the transmission screw 51 drives the shield assembly 40 to move towards the fixing component 521, so that the shield component 41 gradually moves away from the valve port 34, and the valve port 34 gradually forms the opened state. A gas is sucked by using the gas pump, and the gas enters the gas chamber 33 via the gas inlet 32. A gas charging state is formed for the to-be-inflated object by using the valve port 34 and the gas charging channel 31. After gas charging of the to-be-inflated object is completed, the stepper motor 531 runs reversely, to drive the transmission screw 51 to move towards the valve port 34, and drive the shield assembly 40 to move towards the valve port 34, to gradually close the valve port 34. Until the shield assembly 40 returns to the closed state, the power of the drive assembly 50 is cut off, to ensure that the gas in the to-be-inflated object does not flow back, and the to-be-inflated object keeps in a fully charged state.

Compared with the prior art, as regards the screw valve 10 of the present invention, the shield assembly 40 may be driven by using the transmission screw 51 to form the closed state for the valve port 34, the gap between the shield assembly 40 and the transmission screw 51 is adjusted by using the connecting piece 43, and the elastic assembly 54 provides the elastic force for the shield assembly 40 in the closed state, to ensure that the shield assembly 40 keeps the closed state at the valve port 34, and the airtight effect of the screw valve 10 is enhanced.

What is claimed is:

1. A screw valve having an enhanced airtight effect, comprising:
a valve body, including a valve port, a gas inlet, and a gas chamber communicating the valve port and the gas inlet;
a shield assembly, mounted in the gas chamber to shield the valve port, to have an opened state and a closed state for the valve port; and
a drive assembly, mounted in the valve body, and comprising: a transmission screw, a transmission component, an elastic assembly, and a drive unit, wherein the transmission screw extends into the gas chamber and is connected to the shield assembly, a gap is formed between the shield assembly and the transmission screw, the transmission component is connected between the transmission screw and the drive unit, the elastic assembly is disposed between the shield assembly and the transmission component, and provides an elastic force for the shield assembly, the drive unit provides power, when the drive unit provides the power, the transmission screw is driven to drive the shield assembly away from the valve port to form the opened state, and when the drive unit does not provide the power, the shield assembly is driven by the transmission screw to approach the valve port, and the elastic force of the elastic assembly pushes the shield assembly to shield the valve port, to form the closed state, to enhance an airtight effect between the shield assembly and the valve port by using the elastic force of the elastic assembly.

2. The screw valve having an enhanced airtight effect of claim 1, wherein the shield assembly further comprises a shield component closing the valve port, a bracket connected to the shield component, and a connecting piece configured to connect the shield component and the bracket to the transmission screw, so that the gap is formed between the shield assembly and the bracket and the transmission screw by using the connecting piece.

3. The screw valve having an enhanced airtight effect of claim 2, wherein the shield component is further provided with a first embedding portion, and the bracket is provided with a second embedding portion that is embedded with the first embedding portion.

4. The screw valve having an enhanced airtight effect of claim 3, wherein an accommodating space is formed between the shield component and the bracket, a through hole is formed in a direction from the accommodating space to the transmission screw, and the connecting piece is disposed in the accommodating space, and is connected with the transmission screw by using the through hole from the accommodating space.

5. The screw valve having an enhanced airtight effect of claim 1, wherein the valve body is further provided with a gas charging channel, and the valve port is positioned between the gas charging channel and the gas chamber.

6. The screw valve having an enhanced airtight effect of claim 5, wherein a boss is further formed around the valve port, and the boss extends into the gas chamber in a direction from the gas charging channel to the gas chamber, and fits the shield assembly to form the closed state.

7. The screw valve having an enhanced airtight effect of claim 1, wherein the drive unit further comprises a stepper motor and an underdriving gear set, to provide the power by using the stepper motor and then transfer the power to the transmission component by using the underdriving gear set.

8. The screw valve having an enhanced airtight effect of claim 7, wherein the transmission component further comprises a fixing component and a shaft sleeve, the fixing component is fixed in the gas chamber so that the elastic assembly is disposed between the shield assembly and the transmission component, the shaft sleeve is disposed between the fixing component and the underdriving gear set, and is connected with the underdriving gear set, and the transmission screw is connected with the shaft sleeve by using the fixing component to drive, by using the shaft sleeve, the transmission screw to move on the fixing component along an extension direction of a shaft lever.

9. The screw valve having an enhanced airtight effect of claim 8, wherein the transmission component is further internally provided with a screw transmission mechanism sleeved on the transmission screw.
